(19) United States
(12) Patent Application Publication
(10) Pub. No.: US 2023/0088772 A1
(43) Pub. Date: Mar. 23, 2023

(54) AUTOMATICALLY ADJUSTING CUSTOMER PREMISES EQUIPMENT (CPE)

(71) Applicant: Funai Electric Co., Ltd., Daito-shi, Osaka-fu (JP)

(72) Inventors: Phillip SORRELLS, Highland Village, TX (US); David Walter ASH, Kirkland, WA (US); Yanjun MA, Bellevue, WA (US); Vlad Grigore DABIJA, Mountain View, CA (US)

(73) Assignee: Funai Electric Co., Ltd., Daito-shi, Osaka-fu (JP)

(21) Appl. No.: 17/908,862

(22) PCT Filed: Nov. 9, 2020
(86) PCT No.: PCT/US2020/059669

§ 371 Date: Sep. 1, 2022

(51) Int. Cl. H04W 24/02; H04W 16/18; H01Q 1/27

(52) U.S. Cl. CPC H04W 24/02; H04W 16/18; H01Q 1/27

(57) ABSTRACT

Technologies are generally described for automatic adjustment of position and/or location of a customer premises equipment (CPE) to enhance signal quality under varying conditions. Following an initial setup of the CPE, conditions that may degrade signal quality may be monitored and correlated to degradation of the signal quality. Machine learning may be employed to determine new position(s)/location(s) for the CPE and its antenna to improve the signal quality between the CPE and its cellular base station.

### BACKGROUND

Unless otherwise indicated herein, the materials described in this section are not prior art to the claims in this application and are not admitted to be prior art by inclusion in this section.

While modern wireless technologies such as 5G can provide bandwidths comparable to cable networks, the higher frequency ranges utilized by such technologies are susceptible to higher transmission losses and obstructions such as rain, snow, etc. Wireless networks such as 5G networks typically employ customer premises equipment (CPE) to enhance connectivity for devices within buildings. A CPE is commonly set up by an expert or a consumer for optimized line-of-sight with a nearby cell tower but changing conditions over time may degrade the line-of-sight and result in reduced performance for the user devices in the building.

### SUMMARY

The present disclosure generally describes techniques for automatic adjustment of position and/or location of a customer premises equipment (CPE) to enhance signal quality under varying conditions.

According to some examples, a method for adjustment of a customer premises equipment (CPE) may include determining, at a controller, a signal quality of communication between the CPE and a cellular base station; adjusting, by the controller, one or more of a position or a location of the CPE to enhance the signal quality; receiving information associated with one or more environmental parameters; and correlating the adjusted one or more of the position or the location of the CPE with the information associated with the one or more environmental parameters.

According to other examples, a controller configured to adjust a customer premises equipment (CPE) may include a communication device configured to communicate with one or more user devices, sensors, the CPE, and an adjustment module; a memory configured to store instructions; and a processor coupled to the communication device and the memory. The processor, in conjunction with the instructions stored on the memory, may be configured to determine a signal quality of communication between the CPE and a cellular base station; provide instructions to the adjustment module to adjust one or more of a position or a location of the CPE to enhance the signal quality; receive information associated with one or more environmental parameters; and correlate the adjusted one or more of the position or the location of the CPE with the information associated with the one or more environmental parameters. The controller may also include the adjustment module configured to adjust the one or more of the position or the location of the CPE based on the instructions received from the processor.

According to further examples, an adjustable customer premises equipment (CPE) may include a communication module configured to communicate wirelessly with a cellular base station and one or more user devices; an adjustment module configured to adjust one or more of a position or a location of the CPE based on received instructions; and a controller communicatively coupled to the communication module and the adjustment module. The controller may be configured to determine a signal quality of communication between the CPE and the cellular base station; provide instructions to the adjustment module to adjust the one or more of the position or the location of the CPE to enhance the signal quality; receive information associated with one or more environmental parameters; and correlate the adjusted one or more of the position or the location of the CPE with the information associated with the one or more environmental parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of a communication system including a cellular base station, a customer premises equipment (CPE), and user devices;

FIG. 2 includes an architectural illustration of a home with multiple user devices and a static CPE facilitating communications with a cellular base station;

FIG. 3A includes an illustration of a home with a track based automatically adjustable CPE;

FIG. 3B includes an illustration of a home with a drone based automatically adjustable CPE;

FIGS. 4A through 4F include illustrations of various example configurations for a track based automatically adjustable CPE;

FIG. 5 includes example components and actions for a system utilizing an automatically adjustable CPE;

FIG. 6 illustrates major components of an example system utilizing an automatically adjustable CPE;

FIG. 7 illustrates a computing device, which may be used to manage automatic adjustment of a CPE;

FIG. 8 is a flow diagram illustrating an example method for manage automatic adjustment of a CPE that may be performed by a computing device such as the computing device in FIG. 7; and

FIG. 9 illustrates a block diagram of an example computer program product,

all of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to automatic adjustment of position and/or location of a customer premises equipment (CPE) to enhance signal quality under varying conditions.

Briefly stated, technologies are generally described for automatic adjustment of position and/or location of a customer premises equipment (CPE) to enhance signal quality under varying conditions. Following an initial setup of the CPE, conditions that may degrade signal quality may be monitored and correlated to degradation of the signal quality. Machine learning may be employed to determine new position(s)/location(s) for the CPE and its antenna to improve the signal quality between the CPE and its cellular base station.

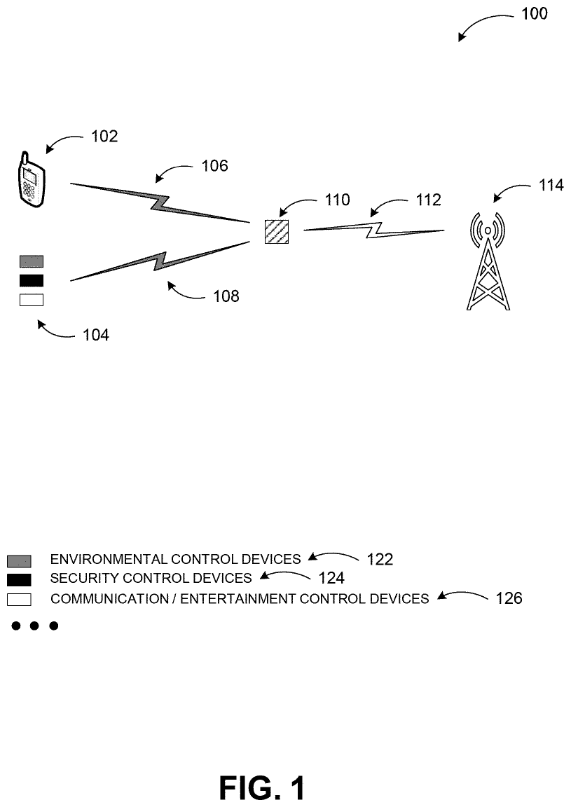

FIG. 1 includes a conceptual illustration of a communication system including a cellular base station, a CPE, and user devices, where some embodiments may be implemented.

Diagram 100 shows a cellular base station 114 wirelessly communicating 112 with a CPE 110, which in turn communicates 106, 108 with a smart phone 102 and a number of user devices 104. User devices 104 may include wireless communication capable devices such as environmental control devices 122, security control devices 124, communication and/or entertainment control devices 126, and similar ones.

With the proliferation of computing and networking technologies, not only are computers of various forms and shapes commonly used in ever increasing numbers, but many devices and appliances found commonly in homes, businesses, and other places are networked too. Typically, user devices ranging from security equipment to household appliances are interconnected through a wireless local area network (LAN) in a house or other building. The wireless LAN is then connected through wired or wireless means to larger networks, for example, the Internet. While wired networks such as cable or DSL are still the more common way of connecting consumers to the Internet, cellular networks are increasingly becoming cost-efficient and provide sufficient bandwidth.

5G is the most recent, fifth generation technology standard for cellular networks. 5G networks are digital cellular networks, in which the service area is divided into small geographical areas called cells. All 5G wireless devices in a cell exchange digital data with the Internet and the telephone network by radio waves through a local antenna in the cell. 5G networks provide greater bandwidth compared to previous standards allowing higher download speeds more than 10 gigabits per second (Gbit/s). This, in turn, allows cellular service providers to become Internet service providers interconnecting most user devices.

5G protocol replaces a number of the hardware components of the cellular network with software that “virtualizes” the network by using the common language of Internet Protocol (IP). The increased speed/bandwidth is achieved in 5G networks partly by using higher-frequency radio waves than current cellular networks. Low band 5G uses a similar frequency range to current 4G network in the 600-700 MHz range supporting download speeds a little higher than 4G (30-250 megabits per second). Mid band 5G uses microwaves in the range of 2.5-3.7 GHz allowing speeds of 100-900 Mbit/s with each cell tower providing service up to several miles in radius. High band 5G uses frequencies in the range of 25-39 GHz, near the millimeter wave band, although higher frequencies may be used in the future. The high band may achieve download speeds of a gigabit per second comparable to cable Internet. However, higher-frequency radio waves have a shorter range than the frequencies used by previous technologies, requiring smaller cells. Millimeter waves, for example, are more susceptible to artificial and natural obstructions such as walls, foliage, even rain.

One approach to increasing reach of higher frequency cellular networks is deployment of customer premises equipment. CPE (also referred to as customer-provided equipment) is any terminal and associated equipment located at a subscriber's premises and connected with a carrier's telecommunication circuit at the demarcation point. The demarcation point is established in a building or complex to separate customer equipment from the equipment located in either the distribution infrastructure or central office of the communications service provider. CPE may include devices such as telephones, routers, network switches, residential gateways, set-top boxes, fixed mobile convergence products, home networking adapters, Internet access gateways, etc. that enable consumers to access providers' communication services and distribute them in a residence or enterprise with a LAN.

A CPE commonly includes at least one antenna to communicate with the cellular base station 114 (cell tower). The CPE 110 may include one or more other antennas to communicate with any smart phones and user devices in or near a building (“on premise”) or use the same antenna to communicate in both directions. For example, an example CPE may communicate with the cellular base station in millimeter wavelengths and use microwave band (e.g., wireless LAN) to communicate with the user devices. Thus, communications 106, 108, and 110 may be in different frequency bands or the same.

A CPE may further include circuitry to provide additional functionality such as communication security (e.g., encryption), signal conditioning, routing, and others. In some cases, some or all of the components (including the antenna(s)) may be integrated in one enclosure or may be in modular form.

According to some embodiments, location and/or position/orientation of a CPE or its antenna for communication with the cellular base station may be adjusted to enhance signal quality in response to changes such as time of day, day of year, etc., as well as, changing obstructions such as weather conditions (rain or snow), foliage, and others. A control system may learn how to adjust the location/position and perform the adjustment automatically resulting in consistent enhanced signal quality.

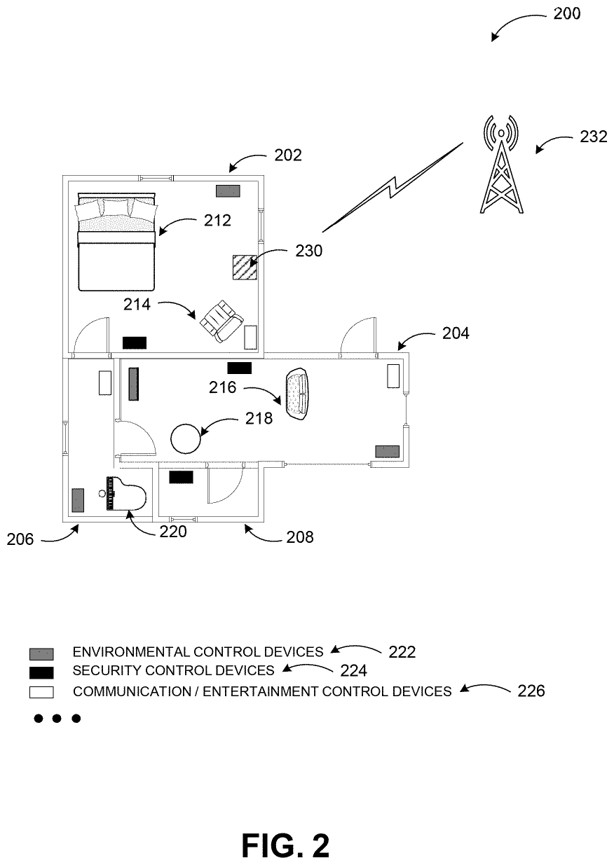

FIG. 2 includes an architectural illustration of a home with multiple user devices and a static CPE facilitating communications with a cellular base station.

Diagram 200 shows top view of various rooms in a home such as bedroom 202, living room 204, auxiliary room 206, and entry 208. The rooms include various furniture and other items such as bed 212, chair 214, couch 216, table 218, piano 220. Various environmental control devices 222, security control devices 224, and communication/entertainment control devices 226 are also dispersed throughout the rooms. The control devices may be in wireless communication with a CPE 230 positioned statically at a location inside the house. The CPE 230 may be in wireless communication with a cellular base station 232.

Within a home or office, the use of 5G may have advantages but may fail to achieve the advantages if the CPE is not properly optimized. Even if a consumer or a professional positions the CPE for best signal quality initially, changing conditions such as weather conditions, obstructions entering or moving out of the line-of-sight may cause the signal quality to degrade. Changing obstructions may include, but are not limited to, rainfall, snow, changing foliage, wind, ice, or actions by animals or humans. In addition to degradation of signal quality outside the building (changing conditions between the CPE and cellular base station), signal quality between the CPE and the user devices inside the building may also degrade due to changing items (e.g., furniture), moving user devices, etc. Thus, a system according to embodiments may not only optimize the CPE's position/location for communication with the cellular base station, but also adjust the CPE's position/location for optimal communication with one or more user devices.

In following figures, example configurations and scenarios are described associated with enhancing signal quality between the CPE and the cellular base station or communication satellites. An example scenario for enhancing signal quality between the CPE and user device(s) may be as follows. A number of control devices and appliances inside the house may be in wireless communication with the CPE. In addition, an occupant's computer and smart phone may also use the CPE to connect to the cellular network. The CPE may adjust its location/position to allow optimal quality of signal for the highest number of user devices or prioritize a group of the user devices. For example, user devices that need higher bandwidth may be prioritized over user devices that need sporadic connection when the CPE's position and/or location is adjusted. Similarly, the position/location optimization may be based on the location of the occupant to allow maximum bandwidth to be provided to the occupant's computer/smart phone. Internal sensors such as cameras, sound sensors, etc. may be used to detect changes in user device location or obstruction locations.

User devices, in communication with the CPE 230, may include, in addition to the various control devices described above, any smart appliance with wireless communication capability, smart speakers, and similar ones. Furthermore, embodiments are not limited to 5G networks. Other wireless technologies such as 4G, LTE, and any current or future cellular wireless technologies or satellite communication technologies may be used in implementing an automatically adjustable CPE/antenna. For example, microwave, satellite, local area network (LAN), whole-city Wifi®, and combinations of similar technologies may be employed in conjunction with an automatically adjustable CPE for dynamically switching between multiple connectivities, or even in a multiple-input-multiple-output (MIMO) like standard, where multiple channels may be used at the same time—giving higher priority to connections that need higher bandwidth on the fastest connections, but also moving the slower less time demanding applications to the lower bandwidth channels.

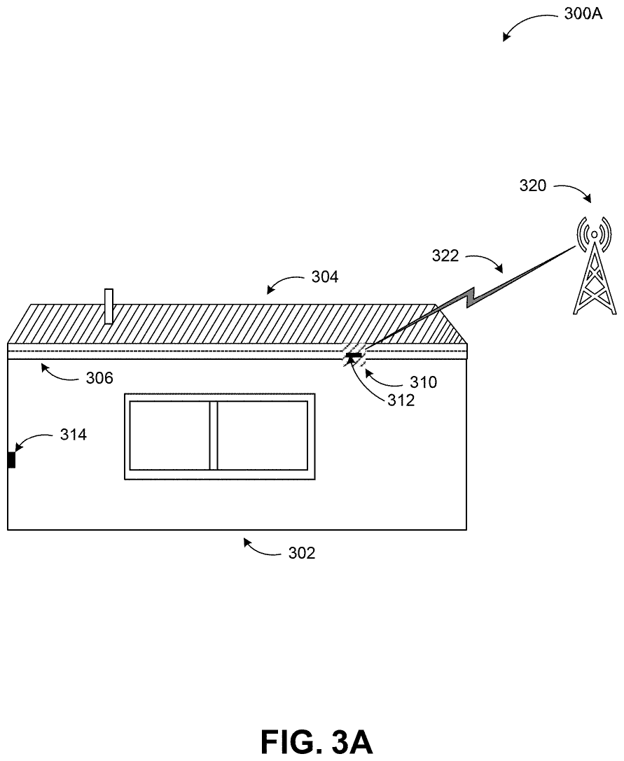

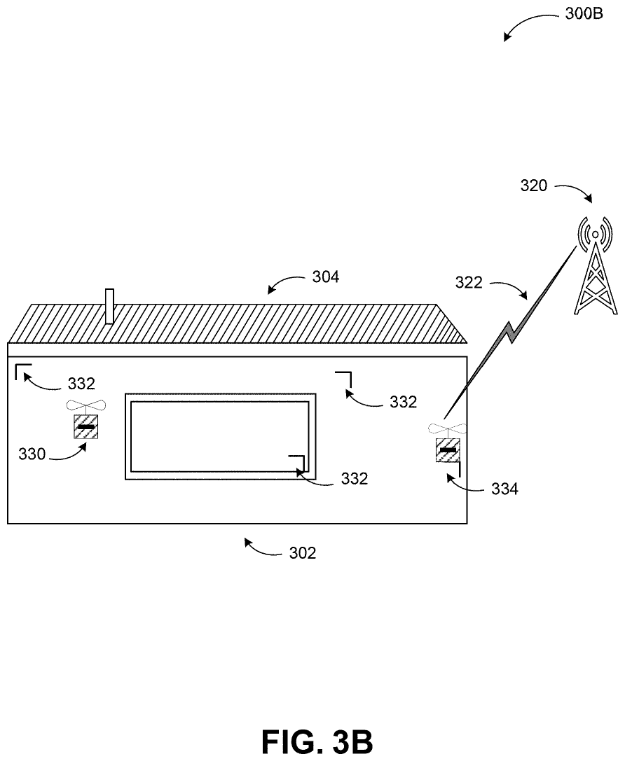

FIG. 3A includes an illustration of a home with a track based automatically adjustable CPE, arranged in accordance with at least some embodiments described herein.

Diagram 300A shows a building 302 (home or office) equipped with a track 306 under the roof (304) line. A CPE 310 along with its antenna 312 is fitted onto the track 306 and movable along the track. The CPE is in wireless communication 322 with a cellular base station 320.

In some examples, the CPE 310 may be placed in a recessed track 306 in an outside location, such as the roof 304 or under the roof line of the building allowing for movement over a larger area. While the recessed track 306 is shown along the roof 304 for illustration purposes, embodiments are not limited to the particular location. A track for moving CPE and/or its antenna may be placed anywhere inside or outside a building. For example, the track may be placed along inside walls, along outside walls (at any height), on a structure installed outside the building, etc. Initial setting of the CPE location may be set by a remote location controller 314 by the consumer or by a professional. Following the initial setup, real time measurements of the signal quality (e.g., signal strength) of the communication 322 may be conducted over time and under changing conditions such as obstructions moving into a line-of-sight. If the signal quality is found to be degraded, the CPE may be moved along the track until the signal quality is maximized. Machine learning may be used to determine which real time adjustments are likely to lead to optimal real time improvements, so as to minimize the amount of time spent experimenting before achieving an optimal configuration.

In other examples, the CPE 310 may be inside the building and the antenna 312 may be placed on the track 306 and moved. The CPE 310 may be coupled to the antenna 312 via a flexible cable. A controller that receives information such as time, weather conditions, obstructions, etc. and controls the movement of the CPE (or the antenna) may be integrated with the CPE 310 or a separate module communicatively coupled to the CPE 310. The motion of the CPE (or the antenna) along the track may be actuated by an electric motor, a micro-electromechanical system (MEMS), or similar systems.

FIG. 3B includes an illustration of a home with a drone based automatically adjustable CPE, arranged in accordance with at least some embodiments described herein.

Diagram 300B shows the building 302 (home or office) the roof 304. Instead of a track, the example configuration in diagram 300B has the CPE in a drone-based setup. CPE 330 may be implemented as a drone capable of autonomously moving to different locations within the building. Landing stations 332 may be placed in suitable locations, where the signal quality of wireless communication 322 with the cellular base station 320 may be better than other locations in the building 302.

In the drone-based configuration, the CPE may be fitted with drone features (e.g., propellers, controller, power source) or attached to a drone. To allow for uninterrupted operation, each of the landing stations 332 may be fitted with a charging station that can provide power to the drone, as well as, the CPE. Locations of the landing stations may be pre-configured (and subsequently adjusted) based on optimal signal quality over time and under changing conditions. The landing stations 332 may be configured such that the CPE can be placed on them in various positions to allow for adjustment of antenna position in addition to location. In some examples, the drone may not need landing stations and may land at any suitable location, for example, using suction cups or a gripping mechanism, etc. Power to the drone and/or CPE may also be provided wirelessly eliminating a need to a wired connection for the drone or the CPE.

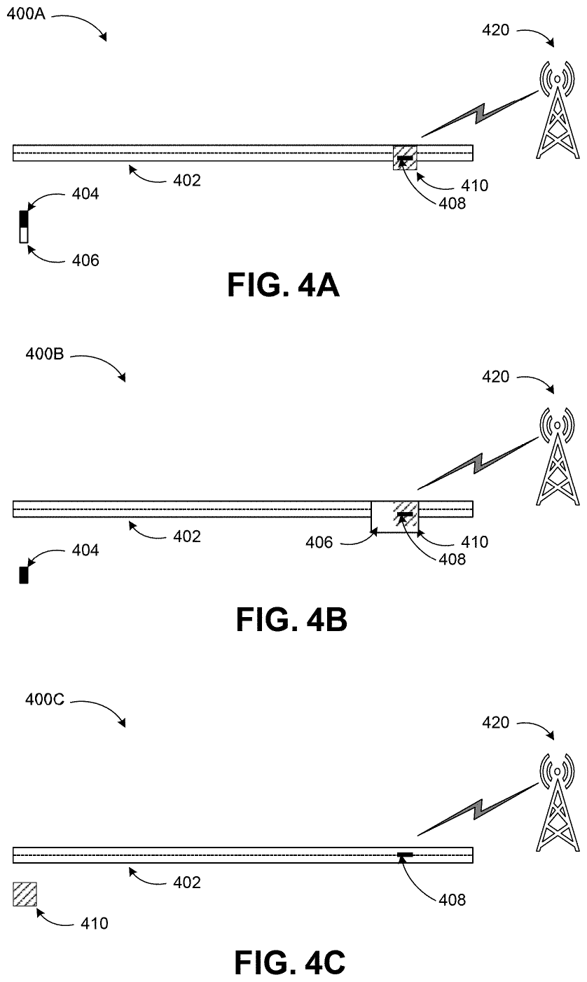

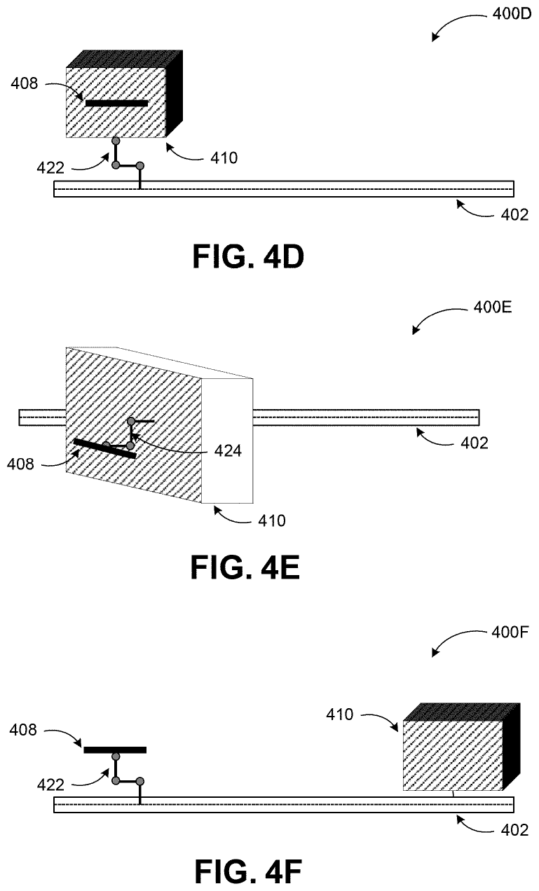

FIGS. 4A through 4F include illustrations of various example configurations for a track based automatically adjustable CPE, arranged in accordance with at least some embodiments described herein.

Diagram 400A shows a track-based configuration with track 402, CPE 410 with its antenna 408 attached to the track 402 and in communication with cellular base station 420. Initial setup controller 404 (e.g. a switch that controls the motion along the track) and location adjustment controller 406 may be remotely located.

The initial setup may simply include turning on and off the switch (controller 404) and select a suitable location (for maximized signal quality) for the CPE 410 along the track 402. The adjustment controller 406 may receive instructions from a remote computing device or input from various sensors and determine a new location for the CPE along the track 402 to improve degrading signal quality. The adjustment controller 406 may control a servo-electric motor or a MEMS to move the CPE 410 along the track 402.

Diagram 400B also includes track 402, cellular base station 420, initial set up controller 404, and CPE 410 with its antenna 408 and adjustment controller 406. Differently from FIG. 4A, the adjustment controller is integrated with the CPE 410 in the configuration of FIG. 4B.

Diagram 400C shows the track 402, cellular base station 420, CPE 410, and antenna 408 attached to the track 402. As discussed previously, the antenna 408 may be coupled to the stationary CPE 410 through a flexible cable and moved along the track 402 in this example configuration. The configuration of FIG. 4C may be implemented with the different controller configurations of FIG. 4A or FIG. 4B.

While the example configurations in FIG. 4A through FIG. 4C show location adjustment for the CPE (or antenna), just modifying the location may not be sufficient to enhance the signal quality. Alternatively, adjusting a position (linearly, planarly, or spatially) of the antenna may further enhance the signal quality. FIGS. 4D through 4F show various example configurations of adjustment of the antenna (or CPE) position in addition to location adjustment. Some example implementations may combine a track with a mechanical gimbal assembly allowing for both large and micro fine-tuning of the antenna pointing direction to peak the beam with the cellular network antenna broadcast. A gimbal is a pivoted support that allows the rotation of an object about a single axis. A set of three gimbals, one mounted on the other with orthogonal pivot axes, may be used to allow an object to remain independent of the rotation of its support. Micromotors, MEMS, or similar devices may be used to move the individual gimbals and set a three-dimensional position for the object (CPE or antenna) mounted on the gimbal assembly. Multiple mechanical options may be employed with varying numbers of degrees of freedom possible. For example, both the specific position of the base of the antenna and the direction that the antenna points to may be freely adjusted in some examples allowing for up to five degrees of freedom (three dimensions for the base of the antenna plus two degrees of freedom for the direction the antenna points). A further degree of freedom may be provided by allowing the entire assembly to move back and forth along its track as it tries to find the optimal position. A gimbal-based assembly may provide two levels of adjustment for the CPE/antenna. Movement along the track may provide linear gross-alignment, whereas positioning of the gimbal may provide fine-tuning for the position and orientation of the antenna planarly or spatially.

Diagram 400D shows track 402 and CPE 410 with its antenna 408 affixed to the track 402 through a gimbal 422. The CPE 410 may be moved along the track 402 (location adjustment) and the gimbal 422 may allow adjustment of the CPE's position (along with the antenna) in three dimensions.

Diagram 400E shows track 402 and CPE 410, which is moved along the track. Antenna 408 is coupled to the CPE 410 through gimbal 424. In this configuration, the location adjustment is performed on the CPE, while position adjustment is performed on the antenna through the gimbal 424.

Diagram 400F shows yet another example configuration, where the CPE 410 is stationary and the antenna 408 is moved along the track 402 and its position adjusted through gimbal 422. Thus, both location and position adjustments are performed on the antenna in this configuration.

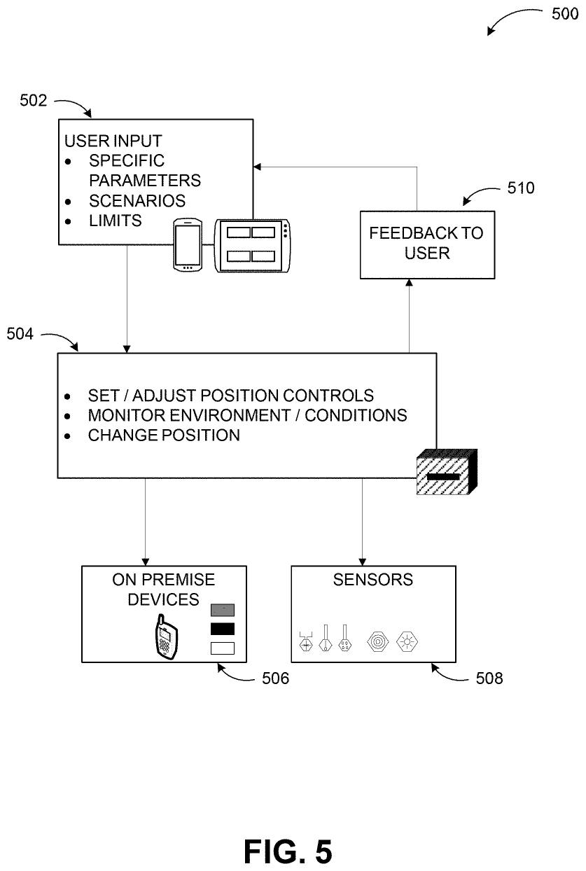

FIG. 5 includes example components and actions for a system utilizing an automatically adjustable CPE, arranged in accordance with at least some embodiments described herein.

Diagram 500 shows major actions by different components of a system according to embodiments. For example, users (or occupants of a building) may be allowed to provide input (502) such as specific environmental parameters, device prioritization scenarios, usage limits, or select among a set of predefined parameters and scenarios through a CPE adjustment control device user interface or a computing device. An application or a browser-based access to the system may allow a user to provide their input in the building associated with the CPE or from any location using any computing device. A server or controller (e.g., a special purpose device), which may be integrated with the CPE may then set or adjust location and/or position for the CPE and its antenna, monitor the environment at the location (for obstructions or degradation of the line-of-sight), monitor user device changes in the building (e.g., a high priority device being activated or de-activated), and instruct mechanical actuators to adjust a location and/or position (504) of the CPE. Thus, the server or controller may control location and position of the CPE/antenna under various conditions. The server or controller may receive signal quality input from on-premise user devices 506 and environmental condition information from sensors 508. The server may also provide feedback 510 to the user through the CPE adjustment control device or the user's computing device.

User devices 506 may include an environmental control device, a security control device, an entertainment control device, a desktop computer, a handheld computer, a smartphone, a smartwatch, a vehicle-mount computer, or a server. The controller may receive signal quality information from a receiver at the CPE or from one or more of the user devices. Environmental parameters (to determine obstructions and degradation of line-of-sight) may include a temperature sensor, a humidity sensor, a sound sensor, a light detection sensor, an air flow sensor, a camera, a user input device, or a remote server. The environmental parameters may include information associated with rain, snow, ice, fog, or physical obstructions such as foliage, other natural obstructions, man-made obstructions (such as structures).

In an example scenario, the CPE may be configured by a human (consumer or expert), and baseline data for the expected signal strength may be obtained. Over time, however, additional data may be gathered as to the signal strength obtained with various values of each of the locations/positions/orientations of the CPE (antenna), along with weather conditions and time of day or week. Artificial Intelligence (AI) algorithms control any device that perceives its environment and takes actions that maximize its chance of successfully achieving predefined goals such as optimizing a position of a CPE and/or its antenna for highest signal quality under varying conditions. A subset of AI, machine learning (ML) algorithms build a mathematical model based on sample data (training data) in order to make predictions or decisions without being explicitly programmed to do so. In some examples, an AI planning algorithm or a specific ML algorithm may be employed to adjust a position of the CPE and/or its antenna to make up for degrading signal quality or data speed. Such an algorithm may receive external conditions data (time, season, weather, obstructions, etc.) and predict a new position for the CPE and/or its antenna for improved signal strength, quality, or data speed. The algorithm may be automatically triggered by when the signal strength, quality, or data speed starts to weaken, and provide its conclusion (new position/configuration) to a controller to set the mechanical devices that adjust the position/location/configuration of the CPE and/or its antenna. An occupant on the premises may also allow ML (training) data to be uploaded to a network so that other users can benefit from their data. The ML algorithm may facilitate both supervised and unsupervised learning. In some examples, the system may use times of day when users are known to be absent or place little demand on the network to experiment with ways to improve performance, without such experimentation disrupting performance in the short term.

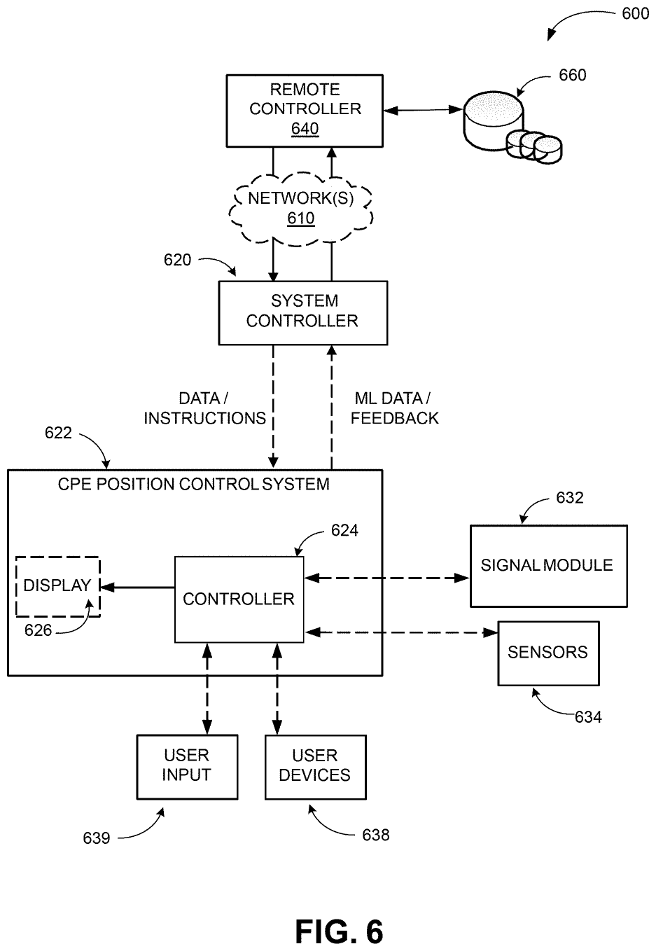

FIG. 6 illustrates major components of an example system utilizing an automatically adjustable CPE, arranged in accordance with at least some embodiments described herein.

Some embodiments may include a system configured to provide automatic adjustment of position and/or location for a CPE to enhance signal quality. An example system as shown in diagram 600 may include a remote controller 640 communicatively coupled to data stores 660 and to a system controller 620 over one or more networks 610. The system may also include a CPE position control system 622. The CPE position control system 622 may include a controller 624 coupled to an optional display 626 to provide information to an occupant of the premises. The premises may include a home, an office, an educational location, a health care location, or similar stationary locations. The premises may also include a mobile location such as a train, a truck, a van, a bus, a boat, a plane, etc.

The CPE position control system 622 may receive one or more environmental parameters associated with the premises such as a home, an office, a vehicle, or similar ones from sensors 634 or user device(s) 638. The environmental parameters may be associated with weather conditions, natural or man-made obstructions in the line-of-sight, etc. The system controller 620 may determine a change in the line-of-sight such as foliage moving in, rain or snow, etc. and compute a new location or position for the CPE to improve quality of signal between the CPE and a cellular base station. The system controller 620 may also receive predefined scenarios from the remote controller 640. One or more position/location control devices may be managed to execute different scenarios and move the CPE or its antenna. The controller may receive signal quality information from one of the user devices 638 or a signal module 632 of the CPE. User input 639 may provide control instructions, manual settings, and/or environmental parameters to the controller 624.

In some examples, CPE position/location adjustment operations may be performed by a controller and instructions for specific actions sent to an adjustment module. In other examples, the CPE position/location adjustment operations may be performed at the CPE. In yet other examples, a central controller (or server) may transmit multiple scenarios to a controller on location and those controllers may execute adjustment scenarios.

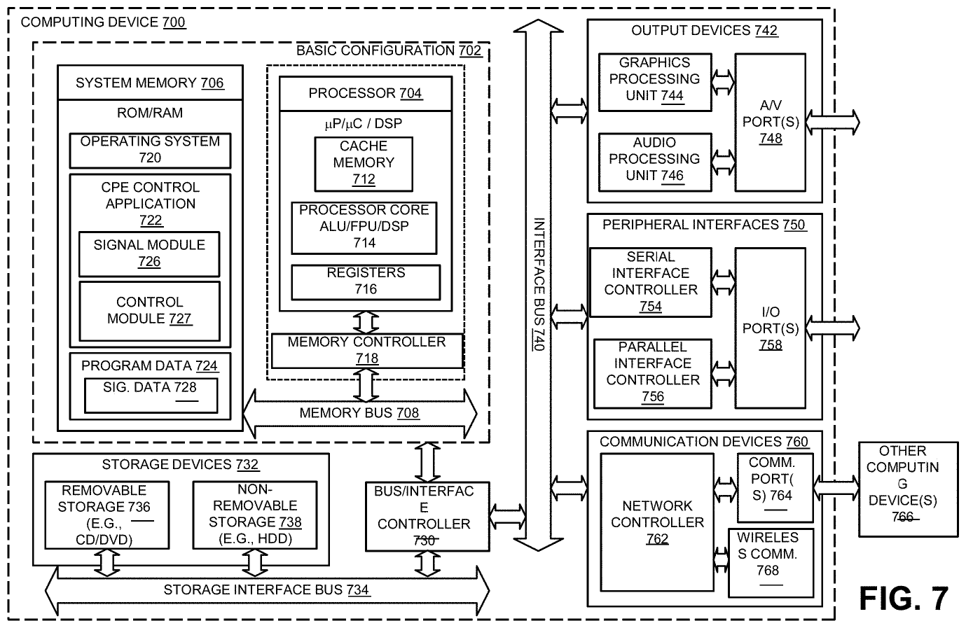

FIG. 7 illustrates a computing device, which may be used to manage automatic adjustment of a CPE, arranged in accordance with at least some embodiments described herein.

In an example basic configuration 702, the computing device 700 may include one or more processors 704 and a system memory 706. A memory bus 708 may be used to communicate between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one or more levels of caching, such as a cache memory 712, a processor core 714, and registers 716. The example processor core 714 may include an arithmetic logic unit (ALU), a floating point unit (FPU), a digital signal processing core (DSP core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a CPE control application 722, and program data 724. The CPE control application 722 may include a signal module 726 and a control module 727. The CPE control application 722 may be configured to receive one or more environmental parameters associated with premises, where the CPE is located, and signal quality. The CPE control application 722 may then determine an adjustment to a position and/or location of the CPE or its antenna to enhance the signal quality. The control module 727 may transmit instructions to one or more position/location control elements to move the CPE or its antenna. The program data 624 may include signal quality data and/or location data 628, among other data, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (e.g., one or more output devices 742, one or more peripheral interfaces 750, and one or more communication devices 760) to the basic configuration 702 via the bus/interface controller 730. Some of the example output devices 742 include a graphics processing unit 744 and an audio processing unit 746, which may be configured to communicate to various external devices such as a display or speakers via one or more A/V ports 748. One or more example peripheral interfaces 750 may include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 760 includes a network controller 762, which may be arranged to facilitate communications with one or more other computing devices 766 over a network communication link via one or more communication ports 764. The one or more other computing devices 766 may include servers at a datacenter, customer equipment, and comparable devices. The network controller 762 may also control operations of a wireless communication module 768, which may facilitate communication with other devices via a variety of protocols using a number of frequency bands such as WiFi®, cellular (e.g., 4G, 5G), satellite link, terrestrial link, etc.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 700 may be implemented as a part of a specialized server, mainframe, or similar computer that includes any of the above functions. The computing device 700 may also be implemented as a personal computer including both laptop computer and non-laptop computer configurations. Furthermore, computing device 700 may be implemented as a standalone, single device, as a distributed computing system, multiple computers co-working with each other, etc.

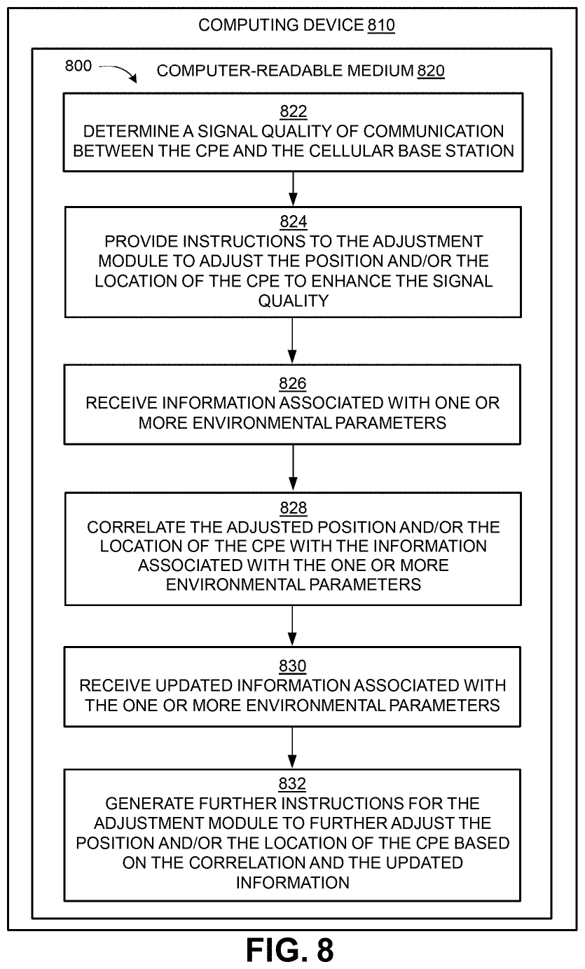

FIG. 8 is a flow diagram illustrating an example method for manage automatic adjustment of a CPE that may be performed by a computing device such as the computing device in FIG. 7, arranged in accordance with at least some embodiments described herein.

Example methods may include one or more operations, functions, or actions as illustrated by one or more of blocks 822, 824, 826, 828, 830, and 832 may in some embodiments be performed by a computing device such as the computing device 700 in FIG. 7. Such operations, functions, or actions in FIG. 8 and in the other figures, in some embodiments, may be combined, eliminated, modified, and/or supplemented with other operations, functions or actions, and need not necessarily be performed in the exact sequence as shown. The operations described in the blocks 822-832 may be implemented through execution of computer-executable instructions stored in a computer-readable medium such as a computer-readable medium 820 of a computing device 810.

An example process to provide automatic adjustment of CPE position/location may begin with block 822, “DETERMINE A SIGNAL QUALITY OF COMMUNICATION BETWEEN THE CPE AND THE CELLULAR BASE STATION”, where a controller or an CPE adjustment application 722 may receive information associated with or determine signal quality (e.g., signal strength, data speed) between a CPE and a cellular base station. The controller or the CPE adjustment application 722 may receive the information from one or more user devices on premises or from a receiver module at the CPE.

Block 822 may be followed by block 824, “PROVIDE INSTRUCTIONS TO THE ADJUSTMENT MODULE TO ADJUST THE POSITION AND/OR THE LOCATION OF THE CPE TO ENHANCE THE SIGNAL QUALITY”, where the controller or the CPE adjustment application 722 may determine (or try) a new location and/or position for the CPE and/or its antenna and provide instructions to an adjustment module to move the CPE and/or its antenna to the new location and/or position. The adjustment module may include servo-electric motor(s), MEMS, or similar electro-mechanical devices. In an example scenario, the adjustment module may include a servo-electric motor to move a CPE antenna along a track and three MEMS to adjust a three-dimensional position of the antenna on a gimbal assembly. Based on instructions received from the controller, the adjustment module may set new parameters for the servo-electric motor and the MEMS moving the antenna to a new location on the track and setting its position through the gimbal assembly.

Block 824 may be followed by block 826, “RECEIVE INFORMATION ASSOCIATED WITH ONE OR MORE ENVIRONMENTAL PARAMETERS”, where the controller or the CPE adjustment application 722 may receive environmental parameters associated with weather conditions, natural or man-made obstructions in the line-of-sight, etc. The controller or the CPE adjustment application 722 may determine a change in the line-of-sight such as foliage moving in, rain or snow, etc.

Block 826 may be followed by block 828, “CORRELATE THE ADJUSTED POSITION AND/OR THE LOCATION OF THE CPE WITH THE INFORMATION ASSOCIATED WITH THE ONE OR MORE ENVIRONMENTAL PARAMETERS”, where the controller or the CPE adjustment application 722 may correlate the signal quality with the receive environmental parameters. For example, if a degradation in the line-of-sight is a repetitive occurrence (e.g., at certain times of day or certain days of the year), the controller or the CPE adjustment application 722 may generate a scenario for the location and/or position of the CPE/antenna based on the repetitive degradation and move the CPE/antenna according to the scenario.

Block 828 may be followed by block 830, “RECEIVE UPDATED INFORMATION ASSOCIATED WITH THE ONE OR MORE ENVIRONMENTAL PARAMETERS”, where the controller or the CPE adjustment application 722 may receive updated environmental parameters, that is changes in line-of-sight obstructions.

Block 830 may be followed by block 832, “GENERATE FURTHER INSTRUCTIONS FOR THE ADJUSTMENT MODULE TO FURTHER ADJUST THE POSITION AND/OR THE LOCATION OF THE CPE BASED ON THE CORRELATION AND THE UPDATED INFORMATION”, where the controller or the CPE adjustment application 722 may determine a further adjustment based on the changes received in the updated environmental parameters and the previously determined correlation. Instructions for moving the CPE/antenna to the new location/position may then be sent to the adjustment module.

The operations included in process 800 are for illustration purposes. Position/location adjustment of CPE may be implemented by similar processes with fewer or additional operations, as well as in different order of operations using the principles described herein. The operations described herein may be executed by one or more processors operated on one or more computing devices, one or more processor cores, and/or specialized processing devices, among other examples.

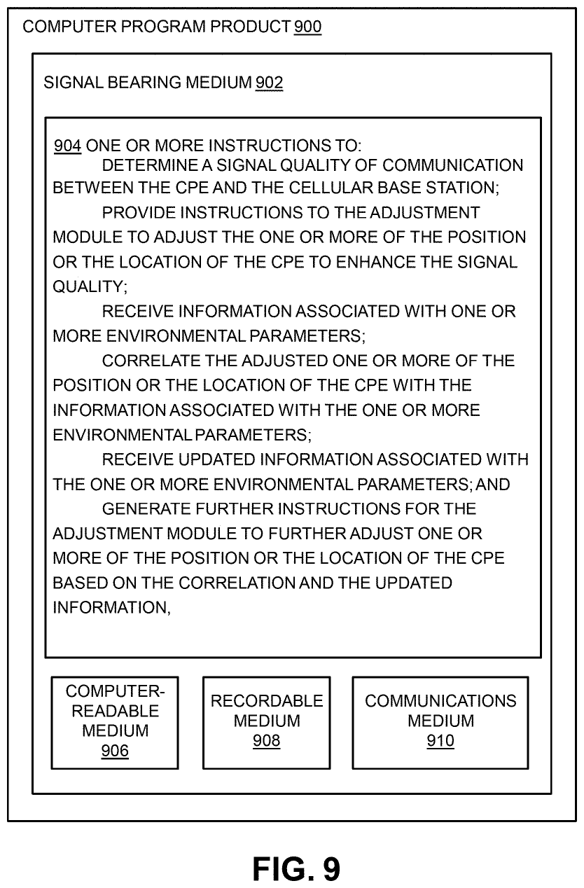

FIG. 9 illustrates a block diagram of an example computer program product, arranged in accordance with at least some embodiments described herein.

In some examples, as shown in FIG. 9, a computer program product 900 may include a signal bearing medium 902 that may also include one or more machine readable instructions 904 that, in response to execution by, for example, a processor may provide the functionality described herein. Thus, for example, referring to the processor 704 in FIG. 7, the CPE control application 722 may perform or control performance of one or more of the tasks shown in FIG. 9 in response to the instructions 904 conveyed to the processor 704 by the signal bearing medium 902 to perform actions associated with the automatic adjustment of CPE position/location as described herein. Some of those instructions may include, for example, determine a signal quality of communication between the CPE and the cellular base station; provide instructions to the adjustment module to adjust the one or more of the position or the location of the CPE to enhance the signal quality; receive information associated with one or more environmental parameters; correlate the adjusted one or more of the position or the location of the CPE with the information associated with the one or more environmental parameters; receive updated information associated with the one or more environmental parameters; and generate further instructions for the adjustment module to further adjust one or more of the position or the location of the CPE based on the correlation and the updated information, according to some embodiments described herein.

In some implementations, the signal bearing medium 902 depicted in FIG. 9 may encompass computer-readable medium 906, such as, but not limited to, a hard disk drive (HDD), a solid state drive (SSD), a compact disc (CD), a digital versatile disk (DVD), a digital tape, memory, and comparable non-transitory computer-readable storage media. In some implementations, the signal bearing medium 902 may encompass recordable medium 908, such as, but not limited to, memory, read/write (R/W) CDs, R/W DVDs, etc. In some implementations, the signal bearing medium 902 may encompass communications medium 910, such as, but not limited to, a digital and/or an analog communication medium (e.g., a fiber optic cable, a waveguide, a wired communication link, a wireless communication link, etc.). Thus, for example, the computer program product 900 may be conveyed to one or more modules of the processor 604 by an RF signal bearing medium, where the signal bearing medium 902 is conveyed by the communications medium 910 (e.g., a wireless communications medium conforming with the IEEE 802.11 standard).

According to some examples, a method for adjustment of a customer premises equipment (CPE) may include determining, at a controller, a signal quality of communication between the CPE and a cellular base station; adjusting, by the controller, one or more of a position or a location of the CPE to enhance the signal quality; receiving information associated with one or more environmental parameters; and correlating the adjusted one or more of the position or the location of the CPE with the information associated with the one or more environmental parameters.

According to other examples, the method may further include receiving updated information associated with the one or more environmental parameters; and further adjusting, by the controller, one or more of the position or the location of the CPE based on the correlation and the updated information. Determining the signal quality of communication between the CPE and the cellular base station may include receiving signal quality information from one or more of a receiver within the CPE or a user device communicatively coupled to the CPE. Adjusting the one or more of the position or the location of the CPE may include moving the CPE or an antenna coupled to the CPE along a track, moving the CPE or an antenna coupled to the CPE through a drone that is mechanically coupled to the CPE or the antenna, or modifying the position of the CPE or an antenna coupled to the CPE through a gimbal linearly, planarly, or spatially.

According to further examples, receiving the information associated with the one or more environmental parameters may include receiving the information associated with one or more of: a time of day, a day of week, a day of year, a weather condition, or an obstruction condition in a line-of-sight between the CPE and the cellular base station. Receiving the information associated with the one or more environmental parameters may also include receiving the information associated with one or more of: a communication traffic exchanged between the CPE and the cellular base station, a number of active user devices associated with the CPE, a location of each active user device associated with the CPE, or a priority level assigned to each active user device associated with the CPE.

According to other examples, a controller configured to adjust a customer premises equipment (CPE) may include a communication device configured to communicate with one or more user devices, sensors, the CPE, and an adjustment module; a memory configured to store instructions; and a processor coupled to the communication device and the memory. The processor, in conjunction with the instructions stored on the memory, may be configured to determine a signal quality of communication between the CPE and a cellular base station; provide instructions to the adjustment module to adjust one or more of a position or a location of the CPE to enhance the signal quality; receive information associated with one or more environmental parameters; and correlate the adjusted one or more of the position or the location of the CPE with the information associated with the one or more environmental parameters. The controller may also include the adjustment module configured to adjust the one or more of the position or the location of the CPE based on the instructions received from the processor.

According to some examples, the processor may be further configured to receive updated information associated with the one or more environmental parameters; and generate further instructions for the adjustment module to further adjust one or more of the position or the location of the CPE based on the correlation and the updated information. The adjustment module may be configured to adjust the one or more of the position or the location of the CPE through one or more of: movement of the CPE or an antenna coupled to the CPE along a track; movement of the CPE or an antenna coupled to the CPE through a drone that is mechanically coupled to the CPE or the antenna; or modification of the position of the CPE or an antenna coupled to the CPE through a gimbal linearly, planarly, or spatially.

According to some examples, to determine the signal quality of communication between the CPE and the cellular base station, the processor may be configured to receive signal quality information from one or more of a receiver within the CPE or a user device communicatively coupled to the CPE. The information associated with the one or more environmental parameters may include information associated with one or more of: a time of day, a day of week, a day of year, a weather condition, or an obstruction condition in a line-of-sight between the CPE and the cellular base station. The information associated with the one or more environmental parameters may include information associated with one or more of: a communication traffic exchanged between the CPE and the cellular base station, a number of active user devices associated with the CPE, a location of each active user device associated with the CPE, or a priority level assigned to each active user device associated with the CPE.

According to other examples, the processor may be configured to receive the information associated with the one or more environmental parameters from one or more of a temperature sensor, a humidity sensor, a sound sensor, a light detection sensor, an air flow sensor, a camera, a microphone, a user input device, or a remote server. The user devices may include one or more of an environmental control device, a security control device, an entertainment control device, a desktop computer, a handheld computer, a smartphone, a smartwatch, a vehicle-mount computer, or a remote server. The CPE may be located at a room, a house, an office, a school, a health care facility, a hotel, a factory, a train, a bus, a recreational vehicle, an airplane, or a ship.

According to further examples, an adjustable customer premises equipment (CPE) may include a communication module configured to communicate wirelessly with a cellular base station and one or more user devices; an adjustment module configured to adjust one or more of a position or a location of the CPE based on received instructions; and a controller communicatively coupled to the communication module and the adjustment module. The controller may be configured to determine a signal quality of communication between the CPE and the cellular base station; provide instructions to the adjustment module to adjust the one or more of the position or the location of the CPE to enhance the signal quality; receive information associated with one or more environmental parameters; and correlate the adjusted one or more of the position or the location of the CPE with the information associated with the one or more environmental parameters.

According to some examples, the controller may be further configured to receive updated information associated with the one or more environmental parameters; and generate further instructions for the adjustment module to further adjust one or more of the position or the location of the CPE based on the correlation and the updated information. The adjustment module may be configured to adjust the one or more of the position or the location of the CPE through one or more of: movement of the CPE or an antenna coupled to the CPE along a track; movement of the CPE or an antenna coupled to the CPE through a drone that is mechanically coupled to the CPE or the antenna; or modification of the position of the CPE or an antenna coupled to the CPE through a gimbal linearly, planarly, or spatially.

According to other examples, to determine the signal quality of communication between the CPE and the cellular base station, the controller may be configured to receive signal quality information from one or more of a receiver within the communication module or a user device communicatively coupled to the CPE. The information associated with the one or more environmental parameters may include information associated with one or more of: a time of day, a day of week, a day of year, a weather condition, or an obstruction condition in a line-of-sight between the CPE and the cellular base station.

According to further examples, the information associated with the one or more environmental parameters may include information associated with one or more of: a communication traffic exchanged between the CPE and the cellular base station, a number of active user devices associated with the CPE, a location of each active user device associated with the CPE, or a priority level assigned to each active user device associated with the CPE. The controller may be configured to receive the information associated with the one or more environmental parameters from one or more of a temperature sensor, a humidity sensor, a sound sensor, a light detection sensor, an air flow sensor, a camera, a microphone, a user input device, or a remote server. The user devices may include one or more of an environmental control device, a security control device, an entertainment control device, a desktop computer, a handheld computer, a smartphone, a smartwatch, a vehicle-mount computer, or a remote server. The CPE may be located at a room, a house, an office, a school, a health care facility, a hotel, a factory, a train, a bus, a recreational vehicle, an airplane, or a ship. The communication module may be configured to communicate wirelessly with the cellular base station and one or more user devices via 5G protocol. The communication module may be configured to communicate wirelessly with the cellular base station via 5G protocol and one or more user devices via a different protocol.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, t some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1-28. (canceled)

29. A method for adjustment of a customer premises equipment (CPE), the method comprising:
determining, at a controller, a signal quality of communication between the CPE and a cellular base station;
adjusting, by the controller, one or more of a position or a location of the CPE to enhance the signal quality;
receiving information associated with one or more environmental parameters;
correlating the adjusted one or more of the position or the location of the CPE with the information associated with the one or more environmental parameters;
receiving updated information associated with the one or more environmental parameters; and
further adjusting, by the controller, one or more of the position or the location of the CPE based on the correlation and the updated information.

30. The method of claim 29, wherein determining the signal quality of communication between the CPE and the cellular base station comprises:
receiving signal quality information from one or more of a receiver within the CPE or a user device communicatively coupled to the CPE.

31. The method of claim 29, wherein adjusting the one or more of the position or the location of the CPE comprises:
moving the CPE or an antenna coupled to the CPE along a track.

32. The method of claim 29, wherein adjusting the one or more of the position or the location of the CPE comprises:
moving the CPE or an antenna coupled to the CPE through a drone that is mechanically coupled to the CPE or the antenna.

33. The method of claim 29, wherein adjusting the one or more of the position or the location of the CPE comprises:
modifying the position of the CPE or an antenna coupled to the CPE through a gimbal linearly, planarly, or spatially.

34. The method of claim 29, wherein receiving the information associated with the one or more environmental parameters comprises:
receiving the information associated with one or more of: a time of day, a day of week, a day of year, a weather condition, or an obstruction condition in a line-of-sight between the CPE and the cellular base station.

35. The method of claim 29, wherein receiving the information associated with the one or more environmental parameters comprises:
receiving the information associated with one or more of: a communication traffic exchanged between the CPE and the cellular base station, a number of active user devices associated with the CPE, a location of each active user device associated with the CPE, or a priority level assigned to each active user device associated with the CPE.

36. A controller configured to adjust a customer premises equipment (CPE), the controller comprising:
a communication device configured to communicate with one or more user devices, sensors, the CPE, and an adjustment module;
a memory configured to store instructions; and
a processor coupled to the communication device and the memory, wherein the processor in conjunction with the instructions stored on the memory is configured to:
determine a signal quality of communication between the CPE and a cellular base station;
provide instructions to the adjustment module to adjust one or more of a position or a location of the CPE to enhance the signal quality;
receive information associated with one or more environmental parameters;
correlate the adjusted one or more of the position or the location of the CPE with the information associated with the one or more environmental parameters; and
the adjustment module configured to adjust the one or more of the position or the location of the CPE based on the instructions received from the processor;
receive updated information associated with the one or more environmental parameters; and
generate further instructions for the adjustment module to further adjust one or more of the position or the location of the CPE based on the correlation and the updated information.

37. The controller of claim 36, wherein the adjustment module is configured to adjust the one or more of the position or the location of the CPE through one or more of:
movement of the CPE or an antenna coupled to the CPE along a track;
movement of the CPE or an antenna coupled to the CPE through a drone that is mechanically coupled to the CPE or the antenna; or
modification of the position of the CPE or an antenna coupled to the CPE through a gimbal linearly, planarly, or spatially.

38. The controller of claim 36, wherein, to determine the signal quality of communication between the CPE and the cellular base station, the processor is configured to:
receive signal quality information from one or more of a receiver within the CPE or a user device communicatively coupled to the CPE.

39. The controller of claim 36, wherein the information associated with the one or more environmental parameters includes information associated with one or more of: a communication traffic exchanged between the CPE and the cellular base station, a number of active user devices associated with the CPE, a location of each active user device associated with the CPE, a priority level assigned to each active user device associated with the CPE, a time of day, a day of week, a day of year, a weather condition, or an obstruction condition in a line-of-sight between the CPE and the cellular base station.

40. The controller of claim 36, wherein the processor is configured to receive the information associated with the one or more environmental parameters from one or more of a temperature sensor, a humidity sensor, a sound sensor, a light detection sensor, an air flow sensor, a camera, a microphone, a user input device, or a remote server.

41. The controller of claim 36, wherein the user devices include one or more of an environmental control device, a security control device, an entertainment control device, a desktop computer, a handheld computer, a smartphone, a smartwatch, a vehicle-mount computer, or a remote server.

42. The controller of claim 36, wherein the CPE is located at a room, a house, an office, a school, a health care facility, a hotel, a factory, a train, a bus, a recreational vehicle, an airplane, or a ship.

43. An adjustable customer premises equipment (CPE) comprising:
a communication module configured to communicate wirelessly with a cellular base station and one or more user devices;
an adjustment module configured to adjust one or more of a position or a location of the CPE based on received instructions; and
a controller communicatively coupled to the communication module and the adjustment module, the controller configured to:
determine a signal quality of communication between the CPE and the cellular base station;
provide instructions to the adjustment module to adjust the one or more of the position or the location of the CPE to enhance the signal quality;
receive information associated with one or more environmental parameters; and
correlate the adjusted one or more of the position or the location of the CPE with the information associated with the one or more environmental parameters;
receive updated information associated with the one or more environmental parameters; and
generate further instructions for the adjustment module to further adjust one or more of the position or the location of the CPE based on the correlation and the updated information.

44. The CPE of claim 43, wherein the adjustment module is configured to adjust the one or more of the position or the location of the CPE through one or more of:
movement of the CPE or an antenna coupled to the CPE along a track;
movement of the CPE or an antenna coupled to the CPE through a drone that is mechanically coupled to the CPE or the antenna; or
modification of the position of the CPE or an antenna coupled to the CPE through a gimbal linearly, planarly, or spatially.

45. The CPE of claim 43, wherein a machine learning algorithm is configured to provide an optimum position or configuration of the CPE in response to a reduction in a signal strength, the signal quality, or a data speed.

46. The CPE of claim 43, the controller is further configured to adjust the one or more of the position or the location of the CPE to an optimum position or location determined by the machine learning algorithm.

47. The CPE of claim 43, wherein the machine learning algorithm is configured to use one or more of external conditions data to determine, wherein external conditions comprise one or more of a time, a season, a weather or an obstruction.

48. The CPE of claim 43, wherein the communication module is configured to communicate wirelessly with the cellular base station via 5G protocol and the one or more user devices via a different protocol.
